(19) United States
(12) Patent Application Publication
(10) Pub. No.: US 2022/0215188 A1
(43) Pub. Date: Jul. 7, 2022

(54) RFID based control subsystem with Tagged switches using Electrically powered RFID tags and Externally controlled RFID Tags

(71) Applicant: Behrouz F-Haghighi, Toronto (CA)

(72) Inventor: Behrouz F-Haghighi, Toronto (CA)

(21) Appl. No.: 17/140,111

(22) Filed: Jan. 3, 2021

(51) Int. Cl. G06K 7/10; G06K 19/07

(52) U.S. Cl. CPC G06K 7/10475; G06K 19/0709

(57) ABSTRACT

An RFID based control subsystem comprises one or more RFID interrogators monitoring tagged switches and communicating with a control system. A Tagged switch is obtained by connecting a switch or contact in series or parallel with an Electrically powered RFID tag. An Electrically powered RFID tag is obtained by removing battery or radiation absorption circuit and adding a suitable circuit and a pair of contacts to a tag that makes it possible to connect a tag to an external power source. A Tagged switch is also obtained by connecting a switch or contact between internal power source and other circuits inside active or passive tag to form a single component wherein power flow is controlled by switch status. An electronic switch could be incorporated on same chip with tag itself.

### BACKGROUND

Traditionally an industrial control system uses switches including electronic switches and auxiliary contacts to collect field data which is used by a processing station to monitor the process. These stations could be the central processing station or a local processing station which then passes the information to central processing station. These switches use wiring for receiving power and transferring data. Each switch or contact within monitoring component or instrument requires one pair of wire which must be connected to control station.

### DESCRIPTION

An RFID based control system uses modified active or semi passive RFID tags for switch and contact identification. The monitoring of the devices and instrument status is performed by RFID interrogators. As the result the wires for transferring data to processing station are not required any more.

A tag could be modified in two ways. In first method that result in an Electrically powered tag an RFID tag could be equipped with the means to receive power from an external electrical source. The tag could be active or passive. In this case a pair of wire and suitable circuitry for receiving power from external source replaces the circuitry for receiving power from internal battery and the battery itself or from radiation from an RFID reader. Then the power could be delivered to tag through the pair of wire or contacts.

It is worth mentioning that the specifications of power circuit depend on the tag application and consequently the type of the tag. Also, the fact that more power is now available to tag brings new possibilities including longer range.

The second way of modifying RFID tags that result in Externally controlled tag is to break the connection between battery in an active tag or circuits providing power in semi passive tags and other circuits inside the tag and provide the means of connecting the two ends to external connection. Again, this could be a pair of wires or contacts on the tag. The pair of wires or contacts are then connected to an external contact or switch which can break or make the connection between tag power supply and other circuits and thus controlling the tag operation. In case electronic switches are used depending on application the switch could be partially or completely incorporated on same chip with the tag.

To form a tagged switch or contact an active or semi passive Electrically powered tag is connected in series to a contact or a switch including electronic switches to form a tagged switch. As such the switch or contact is identified by tag.

When switch is closed then tag is powered, and it sends a signal which can be identified by reader. When switch is open then tag has no power and does not send any signal. Therefore, the information about status of switch could be transferred to processing station by reader and its associated host station.

A parallel configuration of contact and tag is also possible should the need arises, but it requires an extra component in series with the contact to limit the current through contact. The operation here is the reverse of series connected tags. When contact is closed tag has no power and is off. When contact is open tag is powered and can send a signal.

To make a tagged switch or contact using an active or semi passive Externally controlled tag the switch is inserted between the tag contacts or loose end of wires. Consequently, the tag and switch form a single component in which power delivery is controlled by switch. If switch is closed tag is powered and can send signal. If switch is open tag circuits have no power and are disabled.

It should be mentioned that unlike physical switches and contacts like push buttons and relays that must be connected outside of RFID tags electronic switches could be partially or completely incorporated on the same chip with a tag.

Further, the group of instruments which monitor a single or multiple discrete variable limits like a high or low level detector could also be tagged using Electrically powered or Externally controlled tags by tagging the contacts of the instrument including electronic switches.

Eventually the tagged switch can be used to monitor an event. By monitoring the signals from the tag opening and closing actions of contact can be monitored which consequently allows to monitor an event in the process.

The advantage here is that only a few pairs of power lines in more complex situation or just one pair for simple cases is used. The power lines could use any suitable local power supply. Externally controlled tags that use their own battery or radiation power do not need any power lines.

It should be mentioned that today's RFID hosts can use wide range of communication protocols and an interface to a control system is basically a matter of propriety of each control system manufacturer.

1. An Electrically powered RFID tag that has the suitable circuitry including an attached pair of wire or contacts for receiving power from an external electrical power source instead of a battery and associated circuitry or circuitry for receiving radiation power through a physical or electronic switch.

2. An Externally controlled RFID tag wherein the connection between tag battery or circuits providing power and other circuits inside the tag is broken and a pair of wire or contacts is provided for connecting power supply and the other circuits through a physical or electronic switch which is not a component of the tag.

3. A tagged switch or contact comprising of any type of switch including electronic switches or auxiliary contact connected to an Externally controlled RFID tag defined by claim 2 or connected in series or parallel to an Electrically powered RFID tag defined by claim 1 wherein an additional current limiting component in series with the switch is required for parallel configuration.

4. An RFID based control subsystem comprising of one or more tagged switches defined by claim 3 powered by a one or more source of power and corresponding pair of wires in case Electrically powered tags are used and no power line if Externally controlled tags are used wherein tagged switches status of being close or open are monitored by one or more interrogators connected to host stations that are capable of communicating with a local or central control system.
